(19) United States
(12) Patent Application Publication
(10) Pub. No.: US 2022/0391805 A1
(43) Pub. Date: Dec. 8, 2022

(54) ENTERPRISE ASSET MANAGEMENT (EAM) SYSTEM THAT INTEGRATES INTERNET OF THINGS (IOT) DATA

(71) Applicant: International Business Machines Corporation, Armonk, NY (US)

(72) Inventors: SANJAY BHASKARA PANIKKAR, Bangalore (IN); Satish Rajani, Dewas (IN); Shailesh Rajendran Kuttan, Bangalore (IN)

(21) Appl. No.: 17/339,131

(22) Filed: Jun. 4, 2021

(51) Int. Cl. G06Q 10/06; G06Q 10/08

(52) U.S. Cl. CPC G06Q 10/06315; G06Q 10/06312; G06Q 10/0633; G06Q 10/087

(57) ABSTRACT

A method for use with a facility including a plurality of physical assets and an Internet of Things (IoT) sub-system including receiving initial asset data, receiving by an enterprise asset management sub-system (EAM) monitoring data, determining by the EAM that a plurality of changed attribute values have changed, storing in the EAM changed asset data, and taking a responsive action by the EAM.

### BACKGROUND

The present invention relates generally to the field of enterprise asset management (EAM) and also to internet of things (IoT).

The Wikipedia entry for “enterprise asset management” (as of Apr. 20, 2021) states as follows: “Enterprise asset management (EAM) involves the management of the maintenance of physical assets of an organization throughout each asset's lifecycle. EAM is used to plan, optimize, execute, and track the needed maintenance activities with the associated priorities, skills, materials, tools, and information. This covers the design, construction, commissioning, operations, maintenance and decommissioning or replacement of plant, equipment and facilities. ‘Enterprise’ refers to the scope of the assets in an Enterprise across departments, locations, facilities and, potentially, supporting business functions like e.g. Finance & GL, Human Resources and Payroll. Various assets are managed by the modern enterprises at present. The assets may be fixed assets like buildings, plants, machineries or moving assets like vehicles, ships, moving [equipment,] etc. The lifecycle management of the high value physical assets require regressive planning and execution of the work.” (footnote(s) omitted)

The Wikipedia entry for “internet of things” (as of Apr. 20, 2021) states as follows: “The Internet of things (IoT) describes the network of physical objects—‘things’ or objects—that are embedded with sensors, software, and other technologies for the purpose of connecting and exchanging data with other devices and systems over the Internet. Things have evolved due to the convergence of multiple technologies, real-time analytics, machine learning, commodity sensors, and embedded systems. Traditional fields of embedded systems, wireless sensor networks, control systems, automation (including home and building automation), and others all contribute to enabling the Internet of things. In the consumer market, IoT technology is most synonymous with products pertaining to the concept of the ‘smart home’, including devices and appliances (such as lighting fixtures, thermostats, home security systems and cameras, and other home appliances) that support one or more common ecosystems, and can be controlled via devices associated with that ecosystem, such as smartphones and smart speakers. IoT can also be used in healthcare systems. There are a number of serious concerns about dangers in the growth of IoT, especially in the areas of privacy and security, and consequently industry and governmental moves to address these concerns have begun including the development of international standards.” (footnote(s) omitted)

### SUMMARY

According to an aspect of the present invention, there is a method, computer program product and/or system for use with a facility including a plurality of physical assets and an Internet of Things (IoT) sub-system that performs the following operations (not necessarily in the following order): (i) receiving initial asset data including information indicative of: (a) respective identification information for each physical asset of the plurality of assets, and (b) a set of attribute value(s) for each given physical asset of the plurality of physical assets; (ii) receiving, by an enterprise asset management sub-system (EAM), from the IoT sub-system and over a communication network, monitoring data with the monitoring data including information detected by the plurality of IoT sensors in the facility; (iii) determining, by the EAM, that a plurality of changed attribute values have changed relative to respective corresponding attribute values of the initial asset data based on the monitoring data; and (iv) storing, in the EAM, changed asset data reflecting the plurality of changed attribute values.

### BRIEF DESCRIPTION OF THE DRAWINGS

FIG. 1 is a block diagram view of a first embodiment of a system according to the present invention;

FIG. 2A is a flowchart showing a first embodiment method performed, at least in part, by the first embodiment system;

FIG. 2B is a flowchart showing a first embodiment method performed, at least in part, by the first embodiment system;

FIG. 3 is a block diagram showing a machine logic (for example, software) portion of the first embodiment system;

FIG. 4A is a first screenshot view generated by the first embodiment system;

FIG. 4B is a second screenshot view generated by the first embodiment system;

FIG. 5 is a first block diagram view of a second embodiment of a system according to the present invention; and

FIG. 6 is a second block diagram view of a second embodiment of a system according to the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

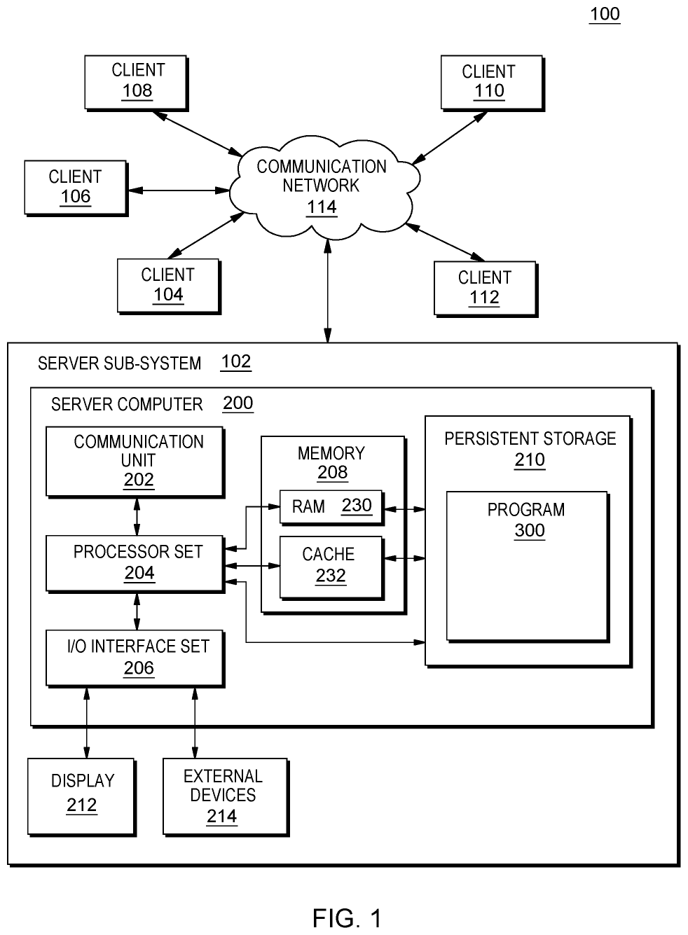

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300. In system 100, client sub-systems 104, 106, 108, 110, 112 are sometimes collectively herein referred to as the “facility.”

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

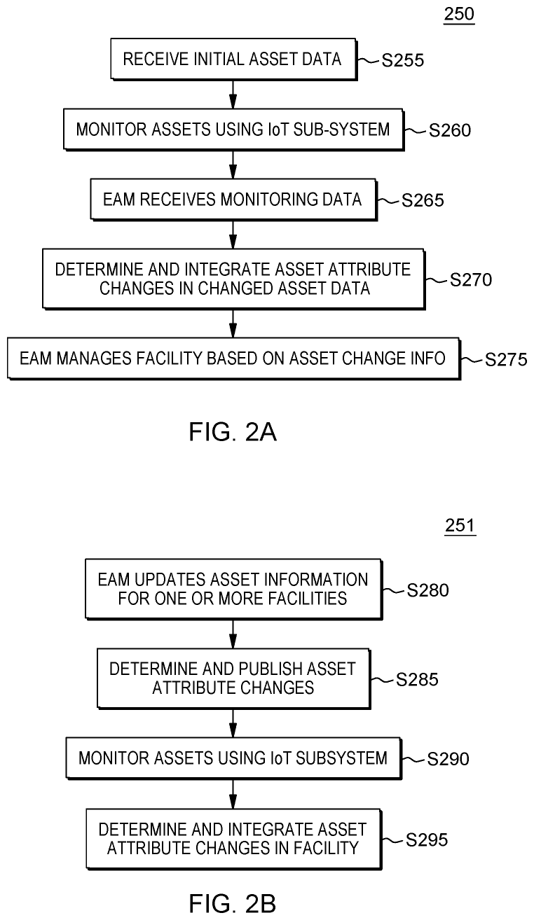

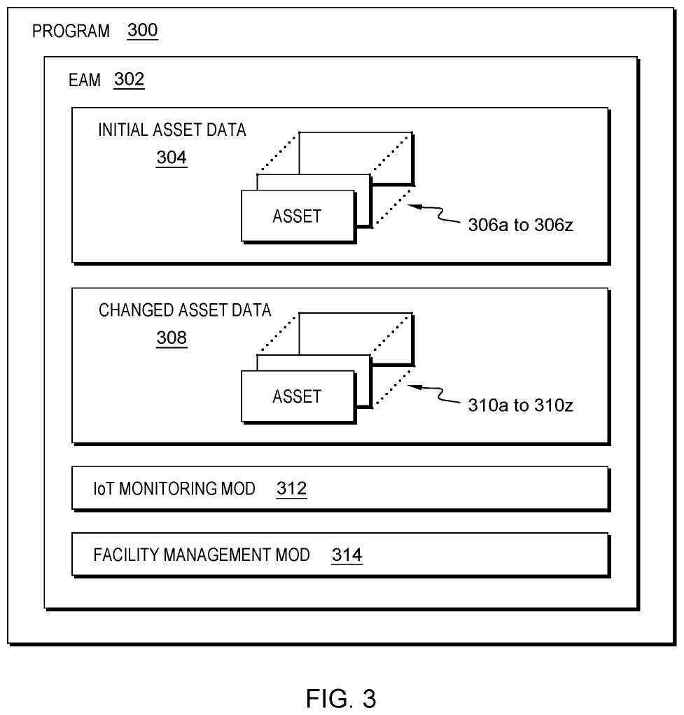

As shown in FIG. 1, networked computers system 100 is an environment in which an example method according to the present invention can be performed. As shown in FIGS. 2A and 2B, flowcharts 250 and 251 show example methods according to the present invention. As shown in FIG. 3, program 300 performs or controls performance of at least some of the method operations of flowcharts 250 and 251. These methods and associated software will now be discussed, over the course of the following paragraphs, with extensive reference to the blocks of FIGS. 1, 2A, 2B, 3, 4A and 4B.

As shown in FIG. 2A, the method of flowchart 250 is a method for attributes and changes from the facility (that is, client sub-systems 104, 106, 108, 110, 112) to an enterprise asset management (EAM) system, which is hosted by server sub-system 102. The operations of flowchart 250 will be discussed in the following paragraphs.

Processing begins at operation S255 where enterprise asset management (EAM) sub-system 302 receives initial asset data 304 from the facility. Initial asset data set 304 includes initial asset data records 306a to 306z. Each asset data record includes information indicative of: (i) identification information that uniquely identifies a corresponding physical that is used in a facility and managed by EAM sub-system 302, and (ii) a set of attribute value(s) for the corresponding physical asset. In this example, data record 306a corresponds to a physical asset in the form of a pencil, which has the unique identifier “PENCIL A”. In this example, data record 306b corresponds to a physical asset in the form of another pencil, which has the unique identifier “PENCIL B”. In this simple example, these two pencils are the only two pencils that the facility has. This supply of pencils is managed by EAM sub-system 302. In this example, it should be understood that the pencils are consumed gradually as they are used and re-sharpened, so EAM sub-system 302 is programmed to manage the facility so that new pencils are ordered before both of the two pencils in “inventory” at any given time will not both be fully used up such that the facility is left with no pencils. At the time of operation S255: (i) PENCIL A is at 67% capacity (or, alternatively, this can be expressed as 33% consumed) which attribute value is included in data record 306a of initial asset data 304; and (ii) PENCIL B is at 25% capacity (or, alternatively, this can be expressed as 75% consumed) which attribute value is included in data record 306a of initial asset data 304.

In this example, the various attribute values of the various data records making up initial asset data 304 is not collected all at one time, but rather received gradually over time by EAM sub-system 302 as the facility operates and EAM sub-system 302 manages the physical assets of the facility. These values may be inputted manually (as is done in currently conventional technology) or be inputted by an IoT sub-system (as is done in various embodiments of the present invention). In other words, the initial state here is not necessarily the initial state at the time that the facility first become operational, and the initial state is not necessarily the state of the physical assets at the start of runtime for the EAM that manages these assets (in this example, EAM sub-system 302), but, rather, it is any arbitrary point in time at which an instance of the method of flowchart 250 is starting to be performed.

In this simple example, the attribute values for PENCIL A and PENCIL B are as follows: (i) pencil capacity (this attribute is the focus of the current discussion); (ii) age of the pencil; (iii) current pencil location; (iv) pencil eraser capacity; (v) hierarchy (parent of pencil, child (if any)); (vi) model of pencil; (vii) rated values of pencil (for example, capacity, max and min operating conditions); and/or (viii) current operating conditions of the pencil. In various embodiments, attribute values of the initial asset data and the changed asset data may correspond to at least one of the following types of attributes: Asset, Location, Asset hierarchy, Asset type, Asset Model, Asset Sub-components, asset custodian(s), asset users, asset repair status, and/or asset capacity level.

Processing proceeds to operation S260, where an IoT sub-system monitors the facility to determine attribute values of the various physical assets in the facility. In this example, the IoT sub-system includes: (i) client sub-systems 104, 106, 108, 110 and 112 (each of which has an IoT sensor that is not separately shown); and (ii) IoT monitoring mod 312. In this simple example, client sub-system 104 is located in the pencil room of the facility (where PENCIL A and PENCIL B are stored and maintained). Client sub-system 104 has an IoT sensor in the form of a camera and machine logic for determining the capacity a pencil has left by determining the pencil length from video captured by the camera of client sub-system 104. As will be appreciated by those of ordinary skill in the art, there are many types of IoT sensors (or types both known now and to be developed in the future), and these may detect/determine, directly and/or indirectly, many different types of attributes corresponding to many different types of physical assets that may be managed by an EAM.

Processing proceeds to operation S265, where IoT monitoring mod 312 of EAM sub-system 302 receives monitoring data from the IoT sub-system. In this example, the various client sub-systems 104, 106, 108, 110 and 112 of the IoT send the data that they have each collected and/or calculated to IoT monitoring mod 312.

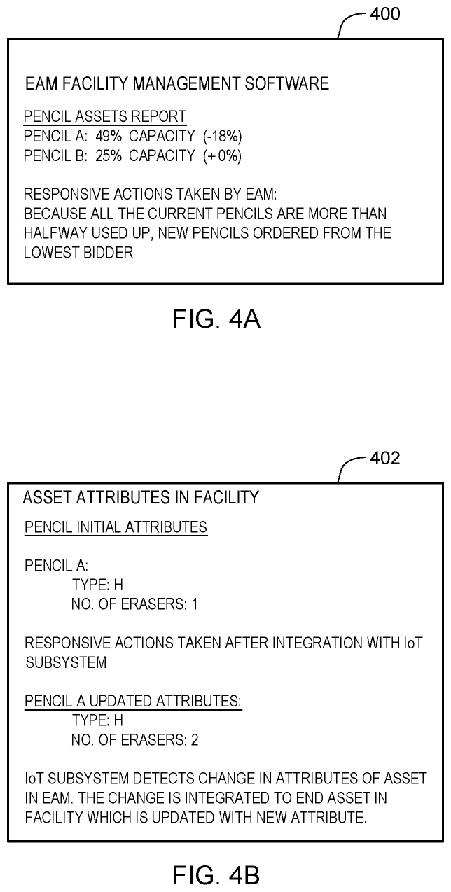

Processing proceeds to operation S270 where mod 312 determines which attribute values have changed relative to respective corresponding attribute values of the initial asset data based on the monitoring data received at operation S260. In this simple example, the value for the asset of capacity of PENCIL B does not change: (i) the capacity value of PENCIL B is 25% in the initial asset data; and (ii) the capacity is still 25% as indicated in the monitoring data based on recent video that captured PENCIL B. This lack of a change in PENCIL B's capacity attribute is shown in screenshot 400 of FIG. 4A. In this simple example, the value for the asset of capacity of PENCIL A does change: (i) the capacity value of PENCIL B is 67% in the initial asset data; and (ii) the capacity is reduced to 49% as indicated in the monitoring data based on recent IoT sensor data that captured PENCIL A because one of the users of PENCIL A sharpened PENCIL A. This change in PENCIL A's capacity attribute is shown in screenshot 400 of FIG. 4A. These detected changes are used to convert initial data 304, with data records 306a to 306z into changed asset data 308 with data records 310a to 310z, which is saved, as shown in FIG. 3. Changed asset data reflects current, up to date information about the physical assets of the facility in near real time.

In this example, the attribute values of the various physical assets, as reflected in the initial asset data and/or the changed asset data, is saved as “asset metadata.” Asset metadata is information about the asset such as Asset Location, Asset Hierarchy, Asset Components, Asset health and status. Such information is grouped as metadata and then stored in Enterprise Asset Management (EAM) systems.

Processing proceeds to operation S275, where facility management mod 314 of EAM sub-system 302 uses its machine logic to determine that it is now time to order new pencils. More specifically, in this simple example, mod 314 includes a machine logic based rule that dictates that the EAM will order two new pencils when both of the existing pencils in the facility fall below 50% capacity. In data records 310a and 310b of changed asset data 308, both pencils are now below 50% capacity (see FIG. 4A), so the machine logic rule for ordering new pencils is invoked and two new pencils are ordered (see bottom portion of screenshot 400). The responsive actions taken by the EAM may include one, or more, of the following types of responsive actions: acquiring new physical asset(s) for the facility, removing physical asset(s) from the facility, instructing repair of physical asset(s), instructing maintenance work on physical asset(s), instructing moving physical asset(s) within the facility, re-assigning custodial oversight of physical asset(s), etc. Further, any changes made by the EAM to update asset information of the pencil for a facility (for example, the number of erasers in a pencil) will be detected as asset attribute changes by the IoT subsystem. In this embodiment, this attribute change is automatically integrated to and changed in the end asset in the facility (see, operations S280 to S295 of flowchart 251 of FIG. 2B).

As shown in FIG. 2B, the method of flowchart 251 is a method for asset attributes and changes from the EAM system to the facility. The flowchart 251 includes the following operations (with process flow among and between operations shown by the arrows in FIG. 2B): S280, S285, S290 and S295. The method of flowchart 251 may be best appreciated by referring to screen shot 402 of FIG. 4B.

### III. Further Comments and/or Embodiments

Some embodiments of the present invention recognize the following facts, potential problems and/or potential areas for improvement with respect to the current state of the art: (i) asset metadata is essential for every enterprise asset management system in building for facility management and maintenance; (ii) asset metadata contains state of the art information about asset location, asset type and its characteristic values associated with sensors; (iii) there are some standard asset metadata schema such as BRICK (building resources for integrated cultural knowledge service) and Project Haystack (that is, a project at the Massachusetts Institute of Technology to research and develop several applications around personal information management and the Semantic Web), which are being used by many building management systems and EAM systems such as enterprise asset management software; (iv) the metadata is required to be updated in the EAM whenever any changes occur on building at the asset and sensor level; and/or (v) implementation of IoT technology in building metadata schema being used by an IoT platform is very much required where the methods used for updating metadata schema in EAM and IoT systems should be done in real time and without manual intervention.

Some embodiments of the present invention recognize the following facts, potential problems and/or potential areas for improvement with respect to the current state of the art where asset metadata building keeps changing due to various reasons such as: (i) addition, transfer and replacement of assets in building including: (a) new asset installation, (b) location information change (latitude, longitude), (c) hierarchy change (asset located in a room, corridor, floor, building, property, zone, etc.), (d) replacement of assets, (e) decommissioning, and/or (f) change in existing asset ID (identification); (ii) addition, transfer, and replacement of sensors associated with asset building including: (a) additional sensor info (for example, additional battery parameters to existing metadata), (b) changed sensor info (for example, measured parameter UOM (units of measurement) change, master information); and/or (c) remove sensors; and/or (iii) parts or sub-assembly replacement including: (a) sub-assembly part replacement during maintenance, and/or (b) the addition of new assembly parts in the asset.

Some embodiments of the present invention recognize the following facts, potential problems and/or potential areas for improvement with respect to the current state of the art where changes to asset metadata building impact the following: (i) enterprise asset management systems need to be updated when changes occur in the field; (ii) applications that refer to EAM information will continue to show wrong information if changes are not reflected; and/or (iii) IoT and sensor data related dashboards and notifications will point to wrong locations when alerts are generated, or actions are recommended (for example, (a) asset parameter malfunctioning will show up in the wrong property/building, and/or (b) a malfunction alert itself could be wrong because UOM changes are not reflected correctly in EAM and IoT systems).

Some embodiments of the present invention recognize the following facts, potential problems and/or potential areas for improvement with respect to the current state of the art pertaining to current ways of updating building metadata schema in the EAM: (i) includes manual changes in the individual field of asset information in the EAM; (ii) offline import or upload of a new metadata schema file in the EAM is required for every update; (iii) API (application programming interface) integration to field systems such as BMS (building management system), whereas BMS is available in the building process; (iv) a combination of manual and automated methods (for example, the use of workflow to initiate approvals/change in the field, (v) changes are approved by following which field systems and EAMs are changed to ensure consistency; and/or (vi) keep IoT systems, EAM, and other systems separate.

Some embodiments of the present invention recognize the following facts, potential problems and/or potential areas for improvement with respect to the current state of the art where current methods include the following limitations: (i) are considered time consuming, non-productive, and are offline; (ii) asset hierarchy and asset information in IoT and EAM systems are separate which creates a deficiency in facility management; (iii) offline or with BMS integration, the EAM gets updated in the metadata schema where the EAM propagates changes in metadata of IoT systems offline, by batch, or via API, which is inefficient and causes false information flow during routine maintenance; (iv) is considered time consuming due to being offline and involving workflow-based methods; (v) not all facilities management field systems are BMS because API based integration is not optimal; (vi) new types of devices and sensors are constantly being added; (vii) integration of sensors and devices to existing field systems (such as BMS) are often challenging because of the diverse types of devices and protocols; (viii) BMS integration with the EAM will not work as a unique method to get the metadata schema for building; and/or (ix) integration and synchronization difficulties will exists in future systems and technologies (for example, digital twin and edge computing).

Some embodiments of the present invention may include one, or more, of the following operations, features, characteristics and/or advantages: (i) using IoT systems, discloses an automatic method to propagate changes in facilities management asset metadata to the EAM in near real time; (ii) discloses an operation of propagating any type of changes in building metadata schema to the EAM using the emerging technology of IoT; (iii) discloses an operation wherein a propagation technique can be initiated automatically after maintenance manager approval; (iv) discloses a step of supporting an IoT system, EAM, and BMS system integration; and/or (v) provides synchronization in the above referenced systems at near real time.

Some embodiments of the present invention may include one, or more, of the following operations, features, characteristics and/or advantages: (i) the use of IoT to propagate changes in near real time and synch various systems is an important differentiator; (ii) a “push to EAM or similar systems” approach is used whenever any changes happen in asset metadata; (iii) a field gateway will publish the desired properties on a topic to an IoT hub which makes it real time; (iv) changes published on the topic will be subscribed by the EAM or other interested systems for further processing; and/or (v) the method is not dependent on a polling approach and will work autonomously.

Some embodiments of the present invention may include one, or more, of the following operations, features, characteristics and/or advantages: (i) provides synchronization between an IoT platform and the EAM; (ii) includes synchronization with building a management system or any standard metadata schema (for example, BRICK and Project Haystack; (iii) supports real time synchronization of metadata in legacy BMS which use a standard building metadata schema via a field gateway; (iv) is not truly autonomous and depends on polling conditions input to determine asset changes; (v) a “push to EAM” approach is used whenever any changes happen in asset metadata; (vi) a field gateway will publish the desired properties on a topic to the IoT hub which makes it real time; (vii) the changes published on the topic will be subscribed by the EAM or other interested systems for further processing; (viii) is not dependent on a polling approach and will work autonomously; and/or (ix) the data points sent will be delta values using lightweight protocols.

Some embodiments of the present invention may include one, or more, of the following operations, features, characteristics and/or advantages: (i) bidirectional changes are possible using the same “push” approach; (ii) if changes from the EAM need to be pushed down to the device or gateway, delta properties will be published to the IoT hub which can then be subscribed by the gateway and pushed to the end device; (iii) a confirmed change in metadata from devices can be reported back to the IoT hub to complete the acknowledgement; (iv) caters to the possibility of a semi-autonomous requirement, that is, the device metadata doesn't necessarily go and automatically change the EAM or other systems' metadata without review and approval; (v) reporting a change to the IoT hub would trigger a smart workflow for facilitating review and approval of changed metadata that can then be published back as approved changes; and/or (vi) the approved changes are used by the EAM and other applications, to make changes in asset hierarchy and metadata.

Some embodiments of the present invention may include one, or more, of the following operations, features, characteristics and/or advantages: (i) overcomes the limitation of updating metadata in the EAM, with adoptive IoT technology, in the building and facility management industry; (ii) uses an automatic IoT system to effectively and efficiently propagate changes in facilities management asset metadata to the EAM in near real time; (iii) propagates any type of changes in building metadata schema to the EAM by using the emerging technology of IoT; (iv) propagation can be initiated after maintenance manager approval or be done automatically; (v) supports IoT systems, EAM, and BMS system integration; and/or (vi) provides synchronization in the above referenced systems at near real time.

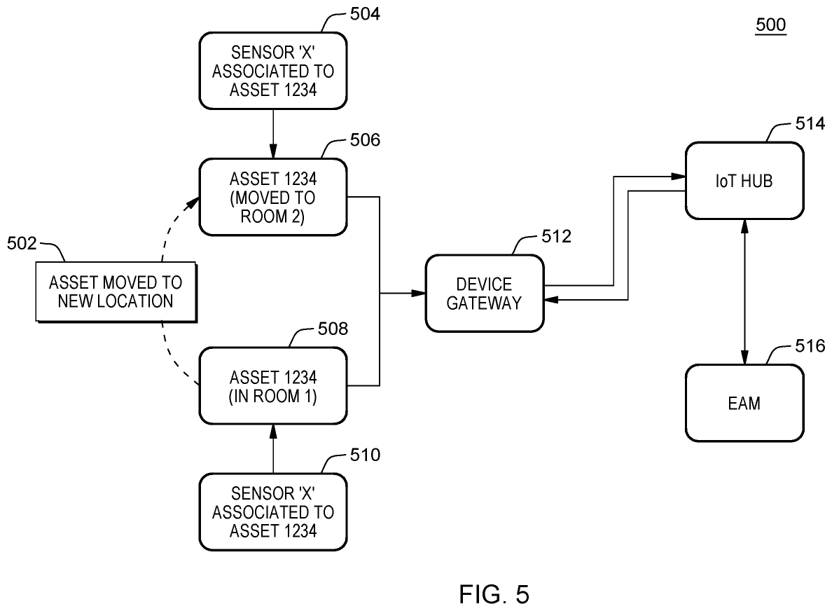

FIG. 5, diagram 500 shows a method of propagation for asset location to the EAM using the IoT hub and includes: asset moved to new location block 502; sensor ‘X’ associated to asset 1234 block 504; asset 1234 (moved to room 2) block 506; asset 1234 (in room 1) block 508; sensor ‘X’ associated to asset 1234 block 510; device gateway block 512; IoT hub block 514; and EAM block 516.

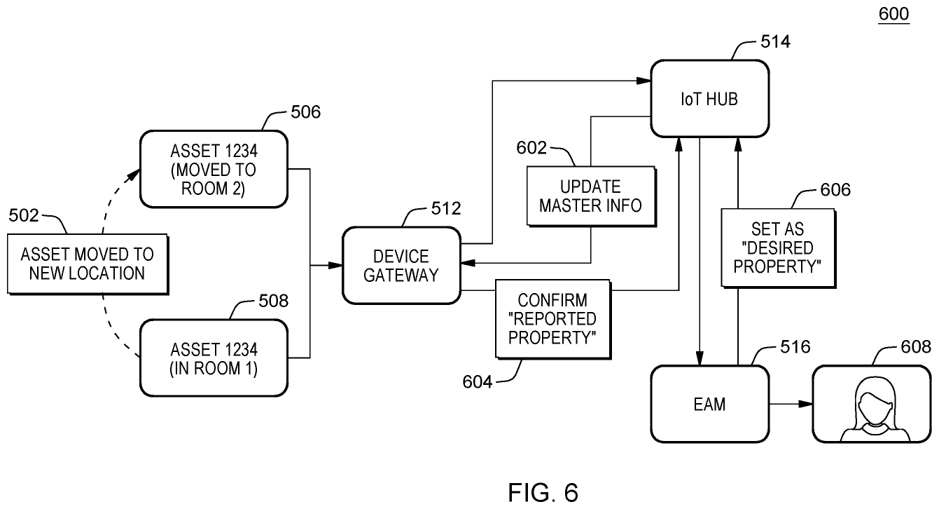

As shown in FIG. 6, diagram 600 includes: asset moved to new location block 502; asset 1234 (moved to room 2) block 506; asset 1234 (in room 1) block 508; device gateway block 512; IoT hub block 514; EAM block 516; update master info block 602; confirm “reported property” block 604; set as “desired property” block 606; and end user block 608.

According to some embodiments of the present invention, the method of using IoT based propagation of changes in the EAM will now be described. In the initial setup, every registered sensor has corresponding state of the art information such as a device twin or device shadow in the IoT system (already available in most public IoT systems). All sensors and sensor metadata associated to an asset will constitute the state of the art definition of an asset in the IoT platform including location of the asset, asset type, and asset hierarchy. The method of propagating changes in the EAM using IoT is shown in FIGS. 5 and 6. Likewise, FIGS. 5 and 6 show an example of the asset location change in two (2) different cases based on approval methods.

The operations shown in FIG. 5, diagram 500 will now be further described in the following five (5) paragraphs.

Operation 1—if location of asset (Asset Id: 1234) gets a change in position (beyond a tolerance value), the associated IoT sensor automatically senses the location information with help of inbuilt proximity location sensors (reference FIG. 5, operation blocks 502, 504, 506, 508, and 510).

Operation 2—the device gateway will update “reported properties” of devices in the device state metadata (such as device twin or device shadow) related to the sensor (Sensor Id: X) (reference FIG. 5, operation block 512). As an example: (1) the existing metadata in the gateway [Location: Room 1, Asset Id: 1234, Sensor Id: X]; and (2) the updated metadata in the device state information [Location: Room 2, Asset Id: 1234, Sensor Id: X].

Operation 3—updated location information in metadata will be sent to the IoT hub as reported properties using lightweight, industry standard protocols like message queuing telemetry transport (MQTT). Acknowledgement will be sent back to the device gateway from the IoT hub as MQTT data as confirmation of the metadata change for the assets in all systems (reference FIG. 5, operation block 512).

Operation 4—all reported changes are accepted as changes made in the field by the IoT hub. No approvals are required (reference FIG. 5, operation block 514). As an example: updated metadata in the IoT hub [Room: Room 2, Asset Id: 1234, Sensor Id: X].

Operation 5—in this location, the changes in metadata will be propagated to the EAM (via API integration). Once the EAM sends acknowledgement of changes back, the IoT hub makes any necessary changes to its own asset metadata by referring back to the EAM. All subsequent messages will be based on the updated asset metadata. Auto updates to the hierarchy can be applied to certain types of assets, where hierarchy changes are desired/frequent (for example, location change for movable assets) (reference FIG. 5, operation block 516).

In some embodiments of the present invention, changes requested by field systems that first require approvals in the IoT hub or in the EAM before propagation are described in the five (5) paragraphs below with reference to FIG. 6.

Any changes in sensor or sensor metadata will be sent to the IoT platform as “requested changes” via lightweight industry standard protocols like MQTT, which most devices and device gateways support. If the device gateway has been updated with a revised location hierarchy, the changed hierarchy alone will be sent as MQTT data as requested property changes for the asset.

The IoT hub will take any requested properties as recommended changes from the field and if any approval workflows need to be triggered, the IoT system will auto-trigger the flow and send to the required personnel. If rejected, the information will be sent back to the device gateway by the IoT hub along with “desired properties” metadata (which in case of rejection, will be the unchanged asset data in the EAM).

If approved by the workflow system, the recommended changes are deemed acceptable. The changes are then updated in the EAM (via API integration). Once the changes are confirmed by the EAM, the new information is set as “desired properties” by the IoT hub and sent to the device gateway along with the approval flag using MQTT.

In either case (approval or rejection), the device gateway takes the command from the IoT hub as master information. Changes effected in the field will be based on “desired properties” sent by the IoT hub for approval.

Once changes are affected in the field, the device gateway will send the “reported” properties back to the IoT Hub to confirm that the desired properties are reflected. Changes will propagate to the EAM via the IoT hub device state metadata.

Some embodiments of the present invention may include one, or more, of the following operations, features, characteristics and/or advantages: (i) provides synchronization in the IoT system and the EAM which help monitoring and maintenance of building effectively; (ii) can apply to building with and without BMS; (iii) can utilize and be extended to new emerging technologies in building, such as using digital twin and edge computing; (iv) is not prone to manual errors; (v) manages asset related changes automatically (zero-touch); (vi) is near real time and lightweight without laborious API or batch integration; (vii) uses existing channels between the asset and the cloud to propagate metadata change; and/or (viii) no additional integrations need to be built or managed.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer implemented method (CIM) for use with a facility including a plurality of physical assets and an Internet of Things (IoT) sub-system including a plurality of IoT sensors, the CIM comprising:
receiving initial asset data including information indicative of: (i) respective identification information for each physical asset of the plurality of assets, and (ii) a set of attribute value(s) for each given physical asset of the plurality of physical assets;
receiving, by an enterprise asset management sub-system (EAM), from the IoT sub-system and over a communication network, monitoring data with the monitoring data including information detected by the plurality of IoT sensors in the facility;
determining, by the EAM, that a plurality of changed attribute values have changed relative to respective corresponding attribute values of the initial asset data based on the monitoring data; and
storing, in the EAM, changed asset data reflecting the plurality of changed attribute values.

2. The CIM of claim 1 further comprising:
taking a responsive action, by the EAM, based, at least in part, on the plurality of changed attribute values.

3. The CIM of claim 1, where the responsive action is one of the following types of responsive actions: acquiring new physical asset(s) for the facility, removing physical asset(s) from the facility, instructing repair of physical asset(s), instructing maintenance work on physical asset(s), instructing moving physical asset(s) within the facility, re-assigning custodial oversight of physical asset(s), update of asset health, location, sub-components, maintain and update inventory, re-order of inventory based on consumption, and/or schedule maintenance based at least on scheduling and asset health.

4. The CIM of claim 1 wherein at least some of the attribute values of the initial asset data and the changed asset data correspond to at least one of the following types of attributes: asset location, asset custodian(s), asset users, asset repair status, asset capacity level, Asset, Location, Asset hierarchy, Asset type, Asset Model and/or Asset Sub-components.

5. The CIM of claim 1 wherein the EAM stores the changed asset data as asset metadata.

6. The CIM of claim 1 wherein the EAM stores the changed asset data in near real time.

7. A computer program product (CPP) for use with a facility including a plurality of physical assets and an Internet of Things (IoT) sub-system including a plurality of IoT sensors, the CPP comprising:
a set of storage device(s); and
computer code stored collectively in the set of storage device(s), with the computer code including data and instructions to cause a processor(s) set to perform at least the following operations:
receiving initial asset data including information indicative of: (i) respective identification information for each physical asset of the plurality of assets, and (ii) a set of attribute value(s) for each given physical asset of the plurality of physical assets,
receiving, by an enterprise asset management sub-system (EAM), from the IoT sub-system and over a communication network, monitoring data with the monitoring data including information detected by the plurality of IoT sensors in the facility,
determining, by the EAM, that a plurality of changed attribute values have changed relative to respective corresponding attribute values of the initial asset data based on the monitoring data, and
storing, in the EAM, changed asset data reflecting the plurality of changed attribute values.

8. The CPP of claim 7 wherein the computer code further includes instructions for causing the processor(s) set to perform the following operation(s):
taking a responsive action, by the EAM, based, at least in part, on the plurality of changed attribute values.

9. The CPP of claim 7, where the responsive action is one of the following types of responsive actions: acquiring new physical asset(s) for the facility, removing physical asset(s) from the facility, instructing repair of physical asset(s), instructing maintenance work on physical asset(s), instructing moving physical asset(s) within the facility, re-assigning custodial oversight of physical asset(s), update of asset health, location, sub-components, maintain and update inventory, re-order of inventory based on consumption, and/or schedule maintenance based at least on scheduling and asset health.

10. The CPP of claim 7 wherein at least some of the attribute values of the initial asset data and the changed asset data correspond to at least one of the following types of attributes: asset location, asset custodian(s), asset users, asset repair status, asset capacity level, Asset, Location, Asset hierarchy, Asset type, Asset Model and/or Asset Sub-components.

11. The CPP of claim 7 wherein the EAM stores the changed asset data as asset metadata.

12. The CPP of claim 7 wherein the EAM stores the changed asset data in near real time.

13. A computer system (CS) comprising for use with a facility including a plurality of physical assets and an Internet of Things (IoT) sub-system including a plurality of IoT sensors, the CS comprising:
a processor(s) set;
a set of storage device(s); and
computer code stored collectively in the set of storage device(s), with the computer code including data and instructions to cause the processor(s) set to perform at least the following operations:
receiving initial asset data including information indicative of: (i) respective identification information for each physical asset of the plurality of assets, and (ii) a set of attribute value(s) for each given physical asset of the plurality of physical assets,
receiving, by an enterprise asset management sub-system (EAM), from the IoT sub-system and over a communication network, monitoring data with the monitoring data including information detected by the plurality of IoT sensors in the facility,
determining, by the EAM, that a plurality of changed attribute values have changed relative to respective corresponding attribute values of the initial asset data based on the monitoring data, and
storing, in the EAM, changed asset data reflecting the plurality of changed attribute values.

14. The CS of claim 13 wherein the computer code further includes instructions for causing the processor(s) set to perform the following operation(s):
taking a responsive action, by the EAM, based, at least in part, on the plurality of changed attribute values.

15. The CS of claim 13, where the responsive action is one of the following types of responsive actions: acquiring new physical asset(s) for the facility, removing physical asset(s) from the facility, instructing repair of physical asset(s), instructing maintenance work on physical asset(s), instructing moving physical asset(s) within the facility, re-assigning custodial oversight of physical asset(s), update of asset health, location, sub-components, maintain and update inventory, re-order of inventory based on consumption, and/or schedule maintenance based at least on scheduling and asset health.

16. The CS of claim 13 wherein at least some of the attribute values of the initial asset data and the changed asset data correspond to at least one of the following types of attributes: asset location, asset custodian(s), asset users, asset repair status, asset capacity level, Asset, Location, Asset hierarchy, Asset type, Asset Model and/or Asset Sub-components.

17. The CS of claim 13 wherein the EAM stores the changed asset data as asset metadata.

18. The CS of claim 13 wherein the EAM stores the changed asset data in near real time.
